(19) United States
(12) Patent Application Publication
(10) Pub. No.: US 2007/0214438 A1
(43) Pub. Date: Sep. 13, 2007

(54) METHOD FOR STATIC POWER CHARACTERIZATION OF AN INTEGRATED CIRCUIT

(76) Inventors: Peter H. Chen Hanping Chen, Taoyuan (TW); Jyh-Herng Wang, Hsin-Chu Hsien (TW); Chih-Yang Peng, Tao-Yuan Hsien (TW); Han-Chi Liu, Kao-Hsiung City (TW); Hsin-Hung Chen, Kao-Hsiung City (TW); Kun-Cheng Wu, Hsin-Chu City (TW)

Correspondence Address: NORTH AMERICA INTELLECTUAL PROPERTY CORPORATION, P.O. BOX 506, MERRIFIELD, VA, 22116, US

(21) Appl. No.: 11/308,154

(22) Filed: Mar. 9, 2006

(51) Int. Cl. G06F 17/50

(52) U.S. Cl. 716/4

(57) ABSTRACT

A method for static power characterization of an analog integrated circuit includes detecting whether each of a plurality of input pins is electrically connected to a specific circuit; selecting a plurality of test benches of the static power characterization according to a number of the input pins electrically connected to the specific circuit; and processing the plurality of selected test benches of the static power characterization.

### BACKGROUND OF THE INVENTION

1. Field of the Invention

The present invention relates to a methodology of automation for characterization of an integrated circuit, and more particularly, to a methodology of automation for static power characterization of an analog integrated circuit.

2. Description of the Prior Art

In the IC design industry, various types of integrated circuits are built as design packages for different purposes in order to facilitate processes of IC design. And those design packages are called IPs. Generally, there are two kinds of methods to characterize static power of analog IPs: one is AC transient characterization, and the other one is DC characterization.

In the prior art, the AC transient characterization involves several steps. First, the IP designer has to spend several hours to run simulation tools (such as SPICE) to generate and store the initial conditions. Then, a plurality of test benches are processed by the simulation tools according to the generated initial conditions for numerous days or even weeks to obtain measured results. Finally, the measured results are averaged to figure out static power of the analog IP.

On the other hand, although the DC characterization does not need to generate initial conditions, and the simulation of each test bench takes only a few seconds to obtain static power attribute of the analog IP, the scale of IPs is getting larger and larger, which makes the total simulation run time of the DC characterization grow exponentially. For example, for an analog IP having 20 input pins, the simulation tools have to switch 0 and 1 states (low and high states) of each input pin to characterize static power of the analog IP for each of the specific temperature conditions, and generally there are three specific temperature conditions: the best case (0° C.), the typical case (25° C.), and the worst case (125° C.). Therefore, there are totally 3×2²⁰ (almost three million) test benches that need to be performed, which is impractical.

In conclusion, the methods for static power characterization of the prior are inefficient and time consuming.

### SUMMARY OF THE INVENTION

It is therefore an objective of the claimed invention to provide a method for static power characterization of an analog integrated circuit in order to solve the problems of the prior art.

The method of the present invention comprises detecting whether each of a plurality of input pins is electrically connected to a specific circuit; selecting a plurality of test benches of the static power characterization according to a number of the input pins electrically connected to the specific circuit; and processing the plurality of selected test benches of the static power characterization.

These and other objectives of the present invention will no doubt become obvious to those of ordinary skill in the art after reading the following detailed description of the preferred embodiment that is illustrated in the various figures and drawings.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of an operational amplifier comprising a NMOS reference circuit.

FIG. 2 is a functional block diagram of an operational amplifier comprising a PMOS reference circuit.

FIG. 3 is a functional block diagram of a multiplexer.

FIG. 4 is a flowchart showing a method of the present invention.

### DETAILED DESCRIPTION

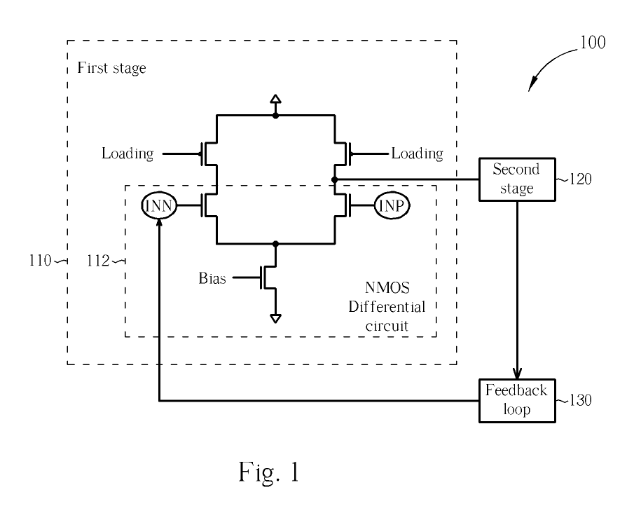

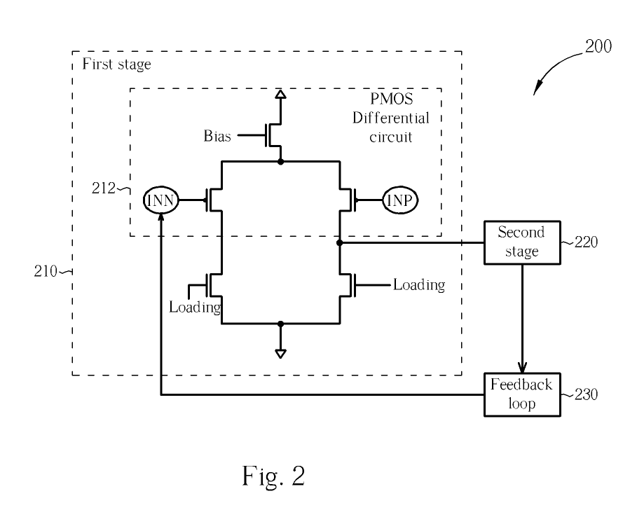

In an analog IP, there may be some input pins of the analog IP electrically connected to some specific circuit that only needs a fixed input, which means the input pin electrically connected to the specific circuit will stay in a fixed state. Therefore, it is not necessary to switch 0 and 1 states of the input pin electrically connected to the specific circuit during DC characterization. Please refer to FIG. 1 to FIG. 2, which shows the specific circuits that only need fixed inputs. FIG. 1 is a functional block diagram of an operational amplifier 100 comprising a NMOS differential circuit 112. FIG. 2 is a functional block diagram of an operational amplifier 200 comprising a PMOS differential circuit 212. The differential circuit 112, 212 is recognized by comprising two input signals (a negative input signal INN and a positive input signal INP) and a differential pair (NMOS pair or PMOS pair). The operational amplifier 100, 200 is recognized by comprising a first stage 110, 210 (includes the differential circuit 112, 212 and loadings), a second stage 120, 220, and a feedback loop 130, 230 between the second stage 120, 220 and the negative input signal INN. Because the differential circuit 112, 212 is utilized for providing a stable reference voltage, and the operational amplifier 100, 200 comprising the differential circuit 112, 212 is utilized for providing driving capacity, the differential circuit 112, 212 and the operational amplifier 100, 200 are only fed with fixed inputs. In the present invention, the differential circuit 112, 212 and the operational amplifier 100, 200 are called fixed state circuits, and those input pins electrically connected to a fixed state circuit will be given a corresponding fixed state during the DC characterization of the present invention.

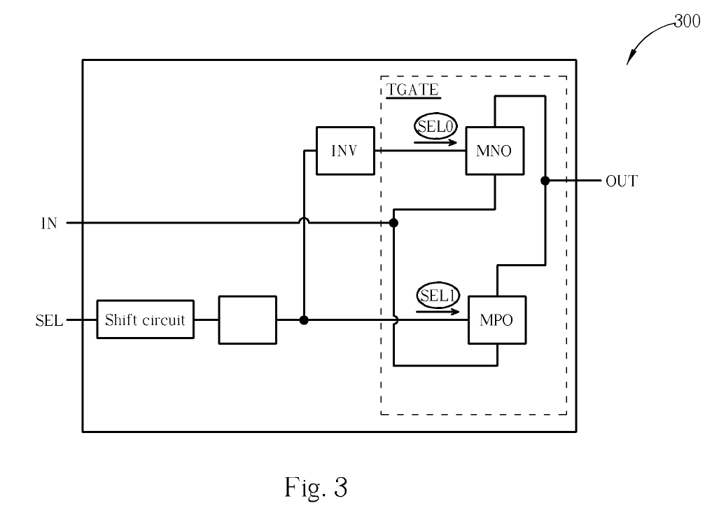

In addition, there is also some specific circuit that doesn't affect power consumption of the analog IP even being switched between 0 and 1 states. Please refer to FIG. 3, which shows a functional block diagram of a multiplexer 300. A typical multiplexer 300 is recognized by comprising a transmission gate TGATE and two opposite selection signals SEL0, SEL1. Because the multiplexer 300 is utilized for routing an input signal IN, the power consumption of the multiplexer 300 remains at the same level while routing the input signal IN. Therefore, it doesn't matter which state of an input pin electrically connected to the multiplexer 300 is given. In the present invention, the multiplexer 300 is called don't care circuit, and those input pins electrically connected to the don't care circuit will be given a predetermined state (either 0 or 1) during the DC characterization of the present invention.

Moreover, the user can further define his own specific circuit, such that any input pin electrically connected to the user defined circuit will be given a specific state according to the user's definition.

Summarizing the above, the present invention can reduce a total number of the test benches of the DC characterization by detecting whether each of a plurality of input pins of an analog IP is electrically connected to a specific circuit (fixed state circuit, don't care circuit, or user defined circuit). For example, for an analog IP having 20 input pins, if finding 8 input pins electrically connected to the fixed state circuits, 4 input pins electrically connected to the don't care circuits, and 3 input pins electrically connected to the user defined circuits, thus during the DC characterization, each of the 8 input pins electrically connected to the fixed state circuit is given a corresponding fixed state, each of the 4 input pins electrically connected to the don't care circuit is given a predetermined state (either 0 or 1), and each of the 3 input pins electrically connected to the user defined circuit is given a specific state according to the user's definition. And then 3×2⁵=96 test benches will be selected for the rest of the 5 input pins not electrically connected to the specific circuits. The 96 test benches are processed by switching 0 and 1 states of the 5 input pins not electrically connected to the specific circuits with three specific temperature conditions: the best case (0° C.), the typical case (25° C.), and the worst case (125° C.). Compared to 3×2²⁰ (almost three million) test benches in the prior art, the present invention minimizes a total number of test benches of the DC characterization.

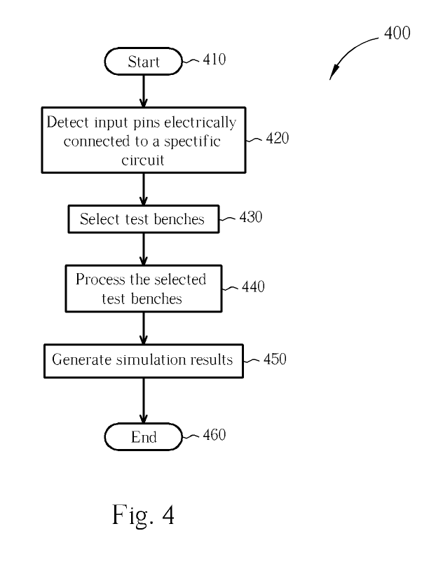

To more clearly illustrate the method for static power characterization of an analog IP, FIG. 4 provides a flowchart 400 of the method of the present invention. Please refer to FIG. 4, the flowchart 400 of FIG. 4 comprises the following steps:

Step 410: Start;

Step 420: Detect whether each of a plurality of input pins of an analog IP is electrically connected to a specific circuit (fixed state circuit, don't care circuit, or user defined circuit);

Step 430: Select a plurality of test benches of the static power characterization according to a number of the input pins electrically connected to the specific circuit;

Step 440: Process the plurality of selected test benches of the static power characterization;

Step 450: Generate simulation results of the selected test benches;

Step 460: End.

Basically, to achieve the same result, the steps of the flowchart 400 need not be in the exact order shown and need not be contiguous, that is, other steps can be intermediate. For example, a step of defining user's specific circuit can be set before step 420. In addition, the above steps can be performed automatically in the present invention.

In contrast to the prior art, the present invention reduces a total number of the test benches of the DC characterization by detecting whether each of a plurality of input pins is electrically connected to a specific circuit. The present invention not only simplifies the static power characterization of an analog IP, but also reduces simulation run time significantly.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for static power characterization of an analog integrated circuit, the method comprising the following steps:
(a) detecting whether each of a plurality of input pins is electrically connected to a specific circuit;
(b) selecting a plurality of test benches of the static power characterization according to a number of the input pins electrically connected to the specific circuit; and
(c) processing the plurality of selected test benches of the static power characterization.

2. The method of claim 1, wherein step (b) comprises selecting a plurality of test benches of the static power characterization according to a total number of the plurality of input pins minus the number of the input pins electrically connected to the specific circuit.

3. The method of claim 1, wherein the specific circuit comprises a differential circuit, and step (c) further comprising setting each of the input pins electrically connected to the specific circuit to be in a corresponding fixed state.

4. The method of claim 1, wherein the specific circuit comprises an operational amplifier, and step (c) further comprising setting each of the input pins electrically connected to the specific circuit to be in a corresponding fixed state.

5. The method of claim 1, wherein the specific circuit comprises a multiplexer, and step (c) further comprising setting each of the input pins electrically connected to the specific circuit to be in a predetermined state.

6. The method of claim 1, wherein step (c) comprises switching states of the input pins not electrically connected to the specific circuit while processing the plurality of selected test benches of the static power characterization.

7. The method of claim 1 wherein the specific circuit is defined by a user.

8. The method of claim 1 being performed automatically.
